(19) United States
(12) Patent Application Publication
(10) Pub. No.: US 2006/0209511 A1
(43) Pub. Date: Sep. 21, 2006

(54) Corky set

(76) Inventors: Penny Carla Bennett-Baird, Brownsville, TX (US); Darryl Duayne Baird, Brownsville, TX (US)

Correspondence Address: Darryl D. Baird, 95 Lakeshore Drive, Brownsville, TX, 78521, US

(21) Appl. No.: 11/368,097

(22) Filed: Mar. 3, 2006

Related U.S. Application Data
(60) Provisional application No. 60/662,211, filed on Mar. 17, 2005.

(51) Int. Cl. G06F 1/20; A47B 19/00

(52) U.S. Cl. 361/687; 361/683; 361/679; 206/576; 312/223.1; 248/441.1

(57) ABSTRACT

The Corky Set includes a screen section, which is an attachment to the frame of a computer monitor that surrounds the screen, a matching mouse section and keyboard section, and a case that contains and permits the full operation of a laptop computer. The screen section permits unprecedented organization of small notes, business cards and small office supply objects. The case permits for the first time the properly ventilated operation of a laptop computer without removal.

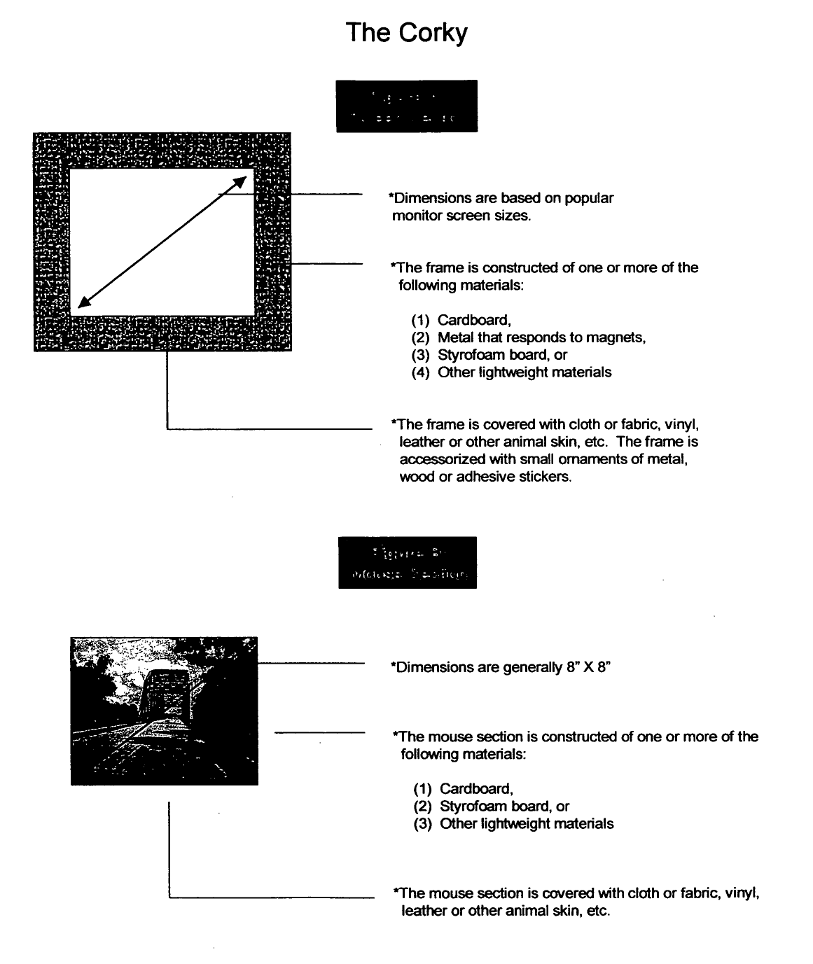

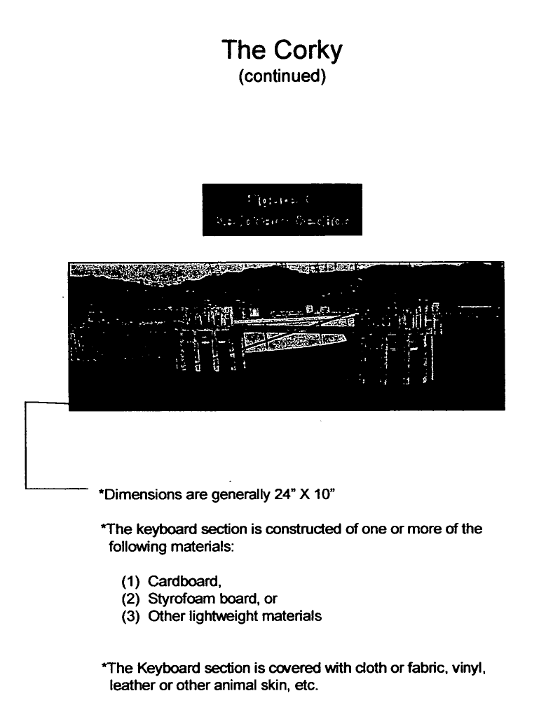

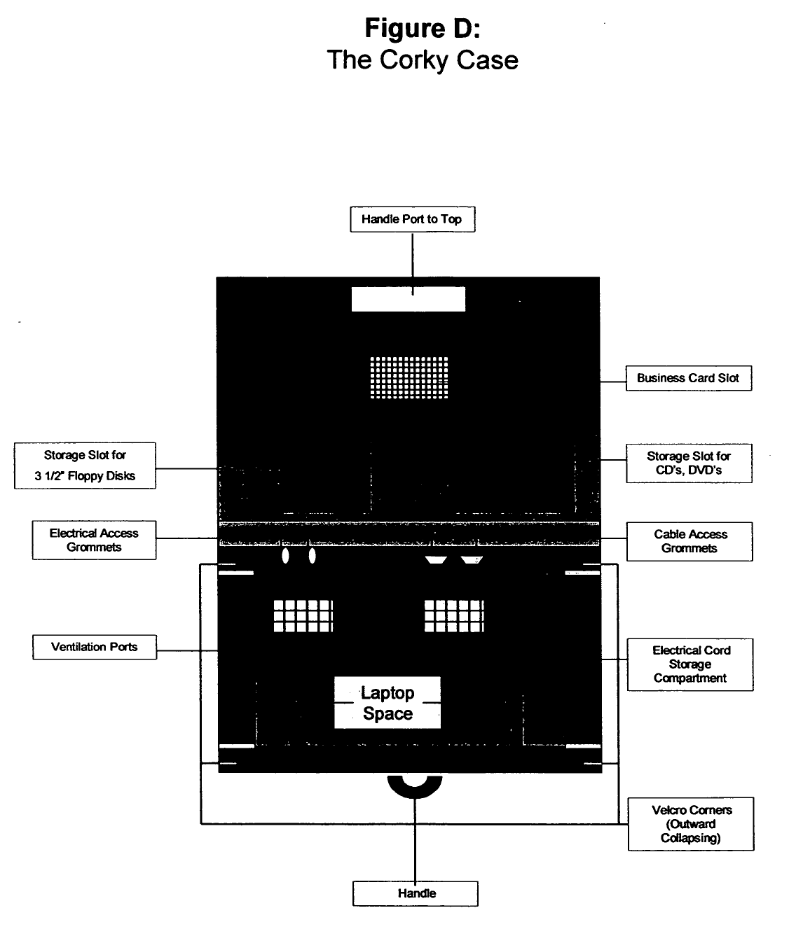

### RELATED APPLICATIONS

Provisional application U.S. 60/662,211, filed Mar. 17, 2005, with applicants Penny Carla Bennett-Baird of Brownsville, Tex., and Darryl Duayne Baird of Brownsville, Tex., for The Corky Set.

### FEDERAL SPONSORSHIP

No federal funds have been expended toward research and development of The Corky Set and, accordingly, the applicants have no rights issues to the invention related to federal sponsorship.

### REFERENCES

No application materials have been submitted by electronic media; all application materials are printed.

### BACKGROUND OF THE INVENTION

The computer monitor is one of the most common occupants of workspace in the American work environment. Work spaces that require computer monitors generally also contain smaller workspace objects, such as pens, notes, paper clips, small photographs and business cards. Such small items are often essential in the storage of important information, such as phone numbers and events to be scheduled.

The placement of these small items in the workplace is often not conducive to or reflective of good workspace organization. With the aforementioned conditions in place, we the inventors have made a few observations. First of all, the perimeter of a computer monitor is typically 49″ or greater. Secondly, notes, business cards and other small papers containing important information cannot be attached to computer monitors by adhesives, tapes, pins or clips in a reliable manner, or without obstruction to the computer screen. Finally, with respect to the use of laptop computers, no existing storage system permits the complete use of a laptop without first removing the laptop computer from its case.

The Corky Set is designed to eliminate the aforementioned problems.

### SUMMARY OF THE INVENTION

The Corky is a device that is made of cardboard or Styrofoam boards, cotton ticking, fabric and Velcro. The device has three parts: The screen section, the mouse section and the keyboard section.

The screen section connects to the frame on a desktop or laptop computer monitor. The screen section has a hollow center to enable full view of the screen on the monitor. The Corky will cling to the surrounding frame on the monitor, enabling the user to attach pushpins, adhesive notes and other items.

The mouse section and the keyboard section are designed to be matching accessories to the Corky, and each are designed to accommodate a desktop computer's mouse and keyboard, respectively.

The laptop case section is designed to allow the full use of a laptop computer without removing it from the case. The case's ventilation ports and its collapsing corners ensure the ventilated use of a laptop computer without removing it from its case.

### DESCRIPTION OF THE SEVERAL VIEWS OF THE DRAWING

Figure A depicts the screen section of the Corky, which consists of a frame configured around popular monitor screen sizes. The center is hollow and the square frame is constructed of cardboard, metal, Styrofoam or other lightweight materials. The frame can be covered, coated or upholstered with a variety of materials, such as cloth or vinyl.

Figure B shows the mouse section of the Corky, generally 8″×8″, and will generally be made of the same material as the screen section. The mouse section could have a photo imprint, as shown in the illustration.

Figure C shows the keyboard section and, with the exception of its 19″×8″ dimensions, has the same construction, materials and features as the mouse section.

Figure D depicts a top view of an open Corky Case. Identified features include a handle and a handle port for closing the Corky Case, storage slots for business cards, floppy disks, CD's, DVD's, a storage compartment for the electric cord, collapsible corners, ventilation ports and grommets for electrical, USB, phone, ethernet and other connections.

### DETAILED DESCRIPTION OF THE INVENTION

The manufacture of the Corky sections are a low-tech undertaking. The machinery necessary to manufacture the Corky Set need not be expensive and the materials used are readily available in the United States.

The supporting materials for the screen section and the mouse section will generally consist of the same sheet of cardboard, metal, Styrofoam board or other appropriate material. Since the dimensions of the mouse section are smaller than all standard computer screen sizes, the mouse section can be cut from the unused centers of the screen sections.

The tools used to cut the screen and mouse section to their proper dimensions are variable and depend upon the materials used. For most prospective supporting materials, cuts can be made with a press with a cutting dye fitting. For a more modest investment, a standard mat cutter, miniature circular saws, band saws, jig saws or, in the case of cardboard or Styrofoam prototypes, a manual box cutter can be used.

The same tools and the same materials may be used for the keyboard section. However, the keyboard section will usually not be cut out of the same sheet as the screen section because the dimensions of both sections combined exceed the dimensions of the sheets of material expected to be used in construction.

Seven pieces of supporting material will be required for the construction of the Corky Case, and five of these sheets will be 2″ wide at various lengths. The remaining two pieces will measure approximately 16″ by 12″, and one of the two remaining pieces will have ventilation ports cut into it.

The Corky screen section, mouse section and keyboard section will have an overlay of cloth or similar materials once the supporting frames are cut. Early prototypes have an overlay of cotton ticking covered with fabric. Insulating materials will be attached to the underlying supporting materials with adhesive liquid or spray. The fabric can also be closed at the bottom or back of the screen section, mouse section and keyboard section with adhesive liquid or spray. The back of the screen section is to be fitted with clips or elastic-lined plastic sheeting to attach to a computer monitor.

Once the seven pieces of supporting materials are made for the Corky Case, these pieces may be covered with one interconnected piece of cloth, fabric or other support, with a layer of insulation between likely consisting of cotton ticking. Once the support pieces are covered with cotton ticking and sheathed with the covering materials as previously described, additional fabric or vinyl pockets can be attached to the outside surface to contain floppy disks or CD's. Additionally, screen material is to be placed over two ventilation ports, and velcro will be attached to the covering materials at various places, including the corners of the 2″ wide supporting materials. Plastic or rubber studs may be placed at the four corners of the back of the support piece with the ventilation ports to slightly elevate the Corky Case off the surface it is placed upon. Finally, a handle will be riveted to the front bottom support piece in a location that allows it to fit through the handle port in the front top support piece when the Corky Case is closed.

The installation of the screen section will involve the attachment of the screen section to a computer monitor by clips or elastic-lined plastic sheeting. Once in place, the screen section may have push pins or adhesive notes attached to its front. In some cases, pockets may be added to contain business cards.

The mouse section and the keyboard section need merely to be placed on a horizontal service, and have the mouse or keyboard, respectively, placed on them.

The Corky Case shall have the side with the plastic or rubber studs placed on a horizontal surface (assuming a laptop computer is already inside). The front top flap shall be flipped back to reveal the top of the laptop computer. Velcro attachments in the corners shall be detached to allow the front and sides to fold down. The rear may optionally fold down as well, or the electrical and cable access grommets in the rear may be used for cable, USB, telephone or ethernet connections to be made in the back. Once the top flap and all sides are folded down, the laptop computer can otherwise be set up and operated as it normally is outside of its case.

The Corky screen section allows the placement of notes, business cards, etc. next to the computer screen, which permits convenient access for appointment or the input of data. The Corky Case enables full use of a laptop computer without removal from its case.

Having made a description of the Corky Set, we make the following claims:

1) No other patented device exists that attaches directly to a computer monitor for the purpose of organizing notes, business cards, photographs and other small papers, and

2) No other patented device exists that permits the ventilated use of a laptop computer inside its carrying case.
